(19) United States
(12) Patent Application Publication
(10) Pub. No.: US 2011/0091129 A1
(43) Pub. Date: Apr. 21, 2011

(54) IMAGE PROCESSING APPARATUS AND METHOD, AND PROGRAM

(75) Inventors: Hideyuki ICHIHASHI, Tokyo (JP); Ken TAMAYAMA, Tokyo (JP); Tamaki EYAMA, Tokyo (JP); Nodoka TOKUNAGA, Tokyo (JP)

(73) Assignee: Sony Corporation, Tokyo (JP)

(21) Appl. No.: 12/878,501

(22) Filed: Sep. 9, 2010

(30) Foreign Application Priority Data
Oct. 21, 2009 (JP) 2009-242242

(51) Int. Cl. G06K 9/40

(52) U.S. Cl. 382/275

(57) ABSTRACT

An image processing apparatus includes a texture extracting unit extracting a texture component of a blurred image in which a blur has occurred and a combining unit combining the texture component of the blurred image extracted by the texture extracting unit with a blur-corrected image obtained by correcting the blur of the blurred image.

### BACKGROUND OF THE INVENTION

1. Field of the Invention

The present invention relates to image processing apparatuses and methods, and programs and, in particular, relates to an image processing apparatus and method, and program suitable for use in correcting an image in which a blur has occurred.

2. Description of the Related Art

In related art, there is a correcting technique of correcting a blur of an image due to hand shake at the time of shooting.

The Richardson-Lucy scheme proposed by L. B. Lucy and William Hardley Richardson is an example of this technique. In this scheme, however, when an inverse problem is solved by using a spectrum falling into a zero point on a frequency axis of a point spread function (PSF), amplified noise and ringing occur at the zero point, for example. Moreover, when the point spread function is not correctly solved, more amplified noise and ringing occur at the zero point, for example.

To get around this problem, a residual deconvolution technique can be used capable of suppressing ringing when the point spread function is correctly found by introducing a gain map (for example, refer to “Image deblurring with blurred/noisy image pairs” by Lu Yuan, Jian Sun, Long Quan, and Heung-Yeung Shum, ACM Transactions on Graphics (TOG), v. 26 n. 3, July 2007).

However, in the residual deconvolution technique of related art, when an error is present in the point spread function, it is difficult to successfully reconstruct structure components and a residual portion of the image, thereby disadvantageously causing more ringing.

To get around this problem, a technique (referred to below as a structure deconvolution technique) can be applied in which a structure/texture separation filter of separating structure components and texture components of an image is incorporated in a still-picture image-stabilization algorithm based on the Richardson-Lucy scheme.

In the structure deconvolution technique, for example, with a total variation filter, which is one type of structure/texture separation filter, structure components and texture components of an image in which a blur has occurred (referred to below as a blurred image) are separated from each other, and blur correction is performed only on the structure components, thereby suppressing the occurrence of noise and ringing.

Here, the structure components represent those constructing an outline of the image, such as a flat portion where the image little changes, a tilted portion where the image gently changes, and a contour and edge of a subject. The texture components represent those constructing details of the image, such as a fine pattern of the subject. Therefore, most of the structure components are included in low-frequency components with a low spatial frequency, and most of the texture components are included in high-frequency components with a high spatial frequency.

### SUMMARY OF THE INVENTION

However, in the structure deconvolution technique, part of information about texture components may be lost, thereby losing details of the image. For example, when the structure deconvolution technique is used to perform blur correction on a blurred image depicted in FIG. 1 in which a blur has occurred due to hand shake, details, such as a fine pattern, of the subject are lost, as depicted in FIG. 2. With this, the image looks flat only with a contour, such as a picture for coloring, and a sense of image resolution is decreased.

This decrease of the sense of image resolution can be suppressed to some degree by adjusting a parameter of the structure/texture separation filter. However, due to a trade-off relation between suppression of the decrease and suppression of the occurrence of noise and ringing, it is difficult to sufficiently suppress the decrease.

It is desirable to increase the sense of image resolution decreased due to blur correction.

According to an embodiment of the present invention, an image processing apparatus includes a texture extracting unit extracting a texture component of a blurred image in which a blur has occurred and a combining unit combining the texture component of the blurred image extracted by the texture extracting unit with a blur-corrected image obtained by correcting the blur of the blurred image.

A mask generating unit is further provided for extracting an edge of the blur-corrected image, extending the edge of the extracted blur-corrected image in a direction in which the blur of the blurred image has occurred, and generating a binary mask image for removing pixels included in the extended edge from a combining range of the combining unit. The combining unit can combine the texture component of the blurred image with the blur-corrected image by using the mask image.

The mask generating unit can further attenuate a frequency component of the mask image higher than a predetermined threshold. The combining unit can combine the texture component of the blurred image with the blur-corrected image by using the mask image with the high-frequency component attenuated.

According to another embodiment of the present invention, an image processing method includes the steps of, by an image processing apparatus, extracting a texture component of a blurred image in which a blur has occurred and combining the extracted texture component of the blurred image with a blur-corrected image obtained by correcting the blur of the blurred image.

According to still another embodiment of the present invention, a program causes a computer to perform a process including the steps of extracting a texture component of a blurred image in which a blur has occurred and combining the extracted texture component of the blurred image with a blur-corrected image obtained by correcting the blur of the blurred image.

According to the embodiments of the present invention, a texture component of a blurred image in which a blur has occurred is extracted, and the extracted texture component of the blurred image is combined with a blur-corrected image obtained by correcting the blur of the blurred image.

According to the embodiments of the present invention, the sense of image resolution decreased due to blur correction can be increased.

### BRIEF DESCRIPTION OF THE DRAWINGS

FIG. 1 illustrates an example of a blurred image;

FIG. 2 illustrates an image obtained by applying a structure deconvolution technique to correct the blurred image of FIG. 1;

FIG. 3 is a block diagram of an image processing apparatus to which an embodiment of the present invention is applied;

FIG. 4 is a block diagram of an example of the structure of a function of a blur correcting unit;

FIG. 5 is a block diagram of an example of the structure of a function of a texture reconstructing unit;

FIG. 6 is a flowchart for describing image correction to be performed by the image processing apparatus to which the embodiment of the present invention is applied;

FIG. 7 illustrates an example of a blurred image;

FIG. 8 illustrates a blur-corrected image obtained by correcting a blur of the blurred image of FIG. 7;

FIG. 9 illustrates an image obtained by attenuating high-frequency components of the blurred image of FIG. 7;

FIG. 10 illustrates a high-frequency blurred image obtained by extracting high-frequency components of the blurred image of FIG. 7;

FIG. 11 illustrates an edge image obtained by extracting an edge of the blur-corrected image of FIG. 8;

FIG. 12 illustrates a mask image for the blur-corrected image of FIG. 8;

FIG. 13 illustrates an output image obtained by reconstructing texture components of the blur-corrected image of FIG. 8;

FIG. 14 illustrates an image obtained by combining the blur-corrected image of FIG. 8 and the high-frequency blurred image of FIG. 10 without using the mask image of FIG. 12;

FIG. 15 illustrates a blur-corrected image obtained by correcting a blur of the blurred image of FIG. 1;

FIG. 16 illustrates a high-frequency blurred image obtained by extracting high-frequency components of the blurred image of FIG. 1;

FIG. 17 illustrates an output image obtained by reconstructing texture components of the blur-corrected image of FIG. 2; and

FIG. 18 is a block diagram of an example of the structure of a computer.

### DESCRIPTION OF THE PREFERRED EMBODIMENTS

A mode for carrying out the present invention (referred to below as an embodiment) is described below in the following order.

1. Embodiment

2. Modification Example

### 1. Embodiment

Example of Structure of Image Processing Apparatus

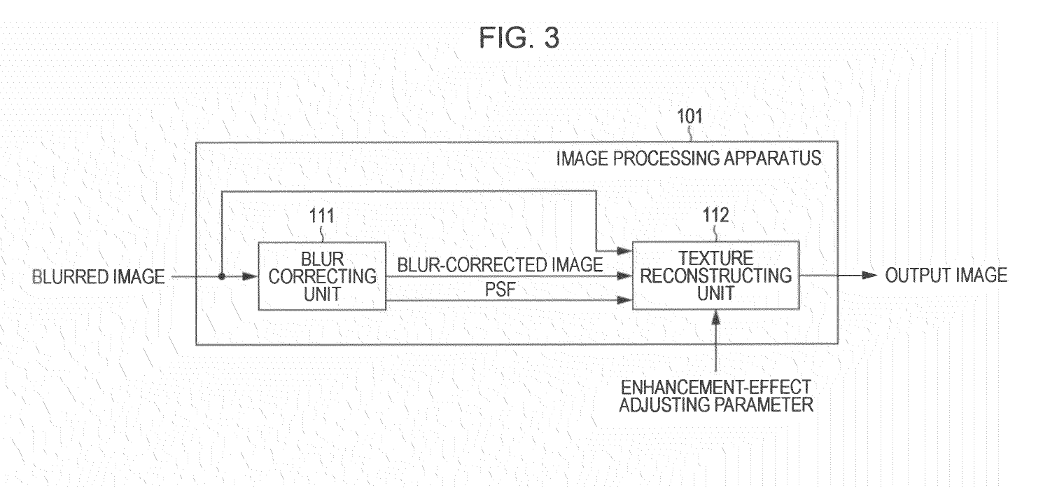

FIG. 3 is a block diagram of an image processing apparatus to which an embodiment of the present invention is applied.

An image processing apparatus 101 of FIG. 3 receives an input of a blurred image in which a blur has occurred due to hand shake or the like, corrects the blur of the input blurred image, and outputs a corrected image (referred to below as an output image). The image processing apparatus 101 is configured to include a blur correcting unit 111 and a texture reconstructing unit 112.

The blur correcting unit 111 finds a point spread function (PSF) indicating a direction and magnitude of the blur of the blurred image and, using the found PSF, corrects the blur of the blurred image. The blur correcting unit 111 supplies an image obtained by correcting the blur (referred to below as a blur-corrected image) and the PSF of the blurred image to the texture reconstructing unit 112.

The texture reconstructing unit 112 uses the blur-corrected image, the blurred image, the PSF, and an enhancement-effect adjusting parameter inputted from outside to reconstruct texture components of the blur-corrected image and increase the sense of resolution. The texture reconstructing unit 112 outputs an image obtained by reconstructing the texture components as an output image to an apparatus of the subsequent stage.

Example of Structure of Blur Correcting Unit

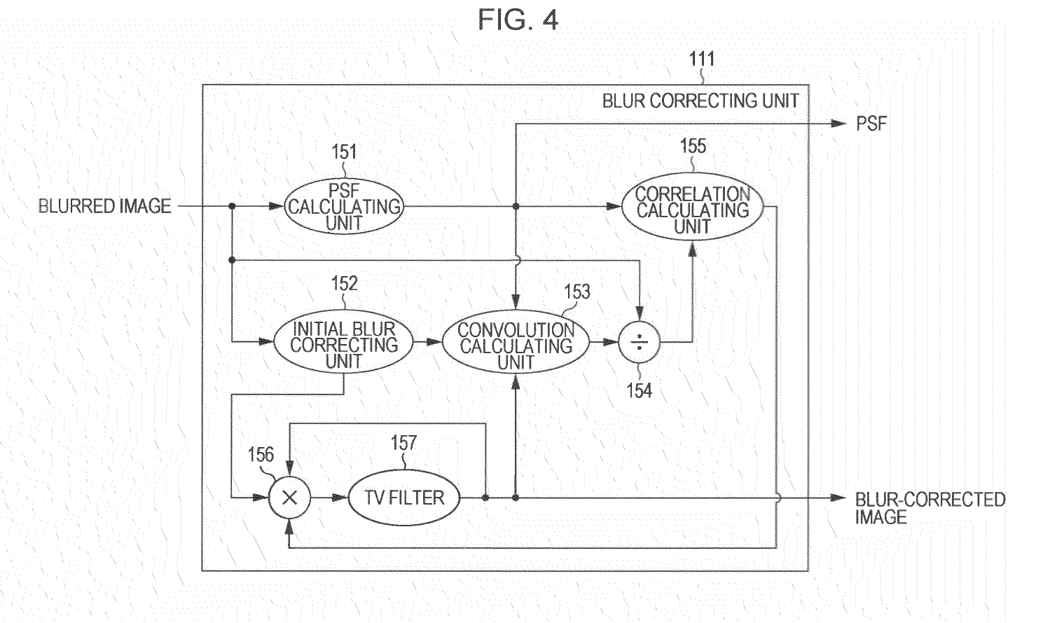

FIG. 4 is a block diagram of an example of the structure of a function of the blur correcting unit 111. The blur correcting unit 111 includes a PSF calculating unit 151, an initial blur correcting unit 152, a convolution calculating unit 153, a residual calculating unit 154, a correlation calculating unit 155, a multiplying unit 156, and a total variation filter 157 (referred to below as a TV filter 157).

A blurred image inputted to the blur correcting unit 111 is supplied to the PSF calculating unit 151, the initial blur correcting unit 152, and the residual calculating unit 154.

The PSF calculating unit 151 uses a predetermined technique to find a PSF of the blurred image, and then supplies the PSF to the convolution calculating unit 153, the correlation calculating unit 155, and the texture reconstructing unit 112.

The initial blur correcting unit 152 corrects the blur of the blurred image by using a predetermined technique based on the PSF of the blurred image. The initial blur correcting unit 152 then supplies an image obtained by correcting the blur (referred to below as an initial blur-corrected image) to the convolution calculating unit 153 and the multiplying unit 156.

The convolution calculating unit 153 performs a convolutional operation between the initial blur-corrected image and the PSF of the blurred image. The convolution calculating unit 153 also performs a convolutional operation between the blur-corrected image supplied from the TV filter 157 and the PSF of the blurred image. That is, the convolution calculating unit 153 performs a convolutional operation between the initial blur-corrected image or the blur-corrected image and blur components of the blurred image represented by the PSF to reproduce the blurred image. The convolution calculating unit 153 then supplies an image obtained as a result of the convolutional operation (referred to below as a reproduced blurred image) to the residual calculating unit 154.

The residual calculating unit 154 finds a difference between the reproduced blurred image and the original blurred image to find a residual between these two images. The residual calculating unit 154 then supplies the operation result to the correlation calculating unit 155.

The correlation calculating unit 155 performs a correlation operation between the PSF of the blurred image and the operation result from the residual calculating unit 154, and removes blur components of the blurred image from the residual between the reproduced blurred image and the blurred image. That is, the correlation calculating unit 155 estimates a residual between the initial blur-corrected image or the blur-corrected image and an image where no blur has occurred. The correlation calculating unit 155 then supplies the operation result to the multiplying unit 156.

The multiplying unit 156 multiplies the initial blur-corrected image supplied from the initial blur correcting unit 152 or the blur-corrected image supplied from the TV filter 157 by the operation result from the correlation calculating unit 155, and then supplies the resultant image to the TV filter 157.

The TV filter 157 separates structure components and texture components of the image generated by the multiplying unit 156. The TV filter 157 then supplies an image formed of the structure components obtained through separation as a blur-corrected image to the convolution calculating unit 153 and the multiplying unit 156. Also, when a predetermined condition is satisfied, the TV filter 157 supplies the blur-corrected image to the texture reconstructing unit 112.

Example of Structure of Texture Reconstructing Unit

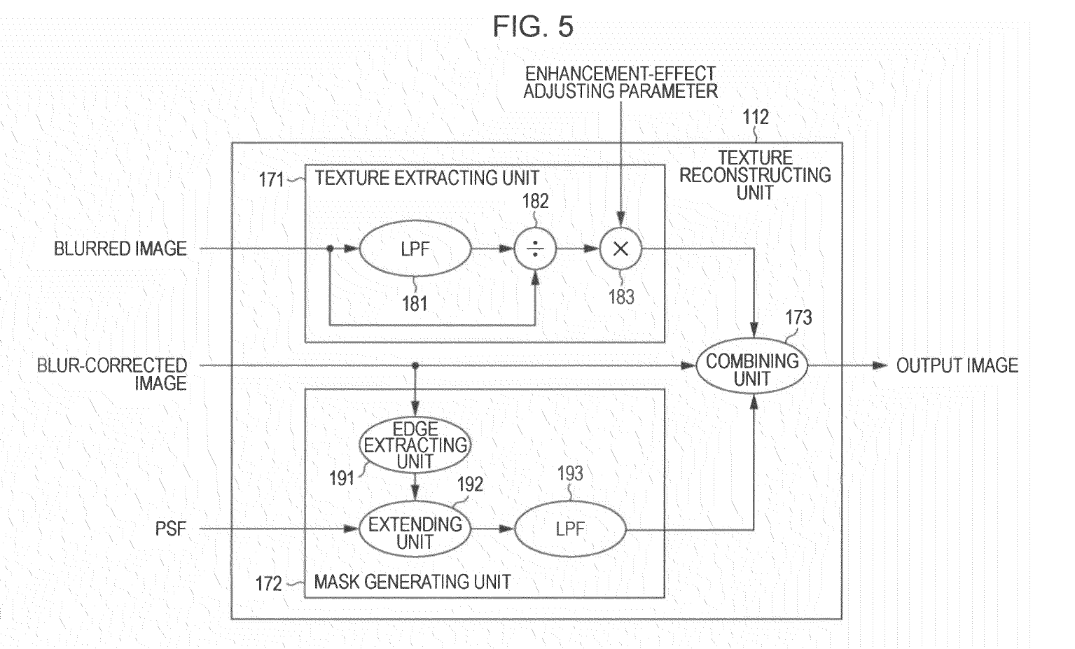

FIG. 5 is a block diagram of an example of the structure of a function of the texture reconstructing unit 112. The texture reconstructing unit 112 is configured to include a texture extracting unit 171, a mask generating unit 172, and a combining unit 173.

The texture extracting unit 171 extracts texture components of the blurred image, and then supplies the extracted texture components to the combining unit 173. The texture extracting unit 171 is configured to include a low-pass filter (LPF) 181, a subtracting unit 182, and a multiplying unit 183.

The LPF 181 attenuates high-frequency components of the blurred image, and then supplies a blurred image obtained by attenuating the high-frequency components to the subtracting unit 182.

The subtracting unit 182 finds a difference between the original blurred image and the blurred image obtained by attenuating the high-frequency components, thereby extracting the high-frequency components of the blurred image. The subtracting unit 182 then supplies an image representing the extracted high-frequency components (referred to below as a high-frequency blurred image) to the multiplying unit 183.

The multiplying unit 183 multiplies each pixel value of the high-frequency blurred image by an enhancement-effect adjusting parameter inputted from outside, thereby enhancing the high-frequency components of the high-frequency blurred image. The multiplying unit 183 then supplies a high-frequency blurred image obtained by enhancing the high-frequency components to the combining unit 173.

The mask generating unit 172 generates a mask image for use when the combining unit 173 combines the blur-corrected image and the high-frequency blurred image. The mask generating unit 172 is configured to include an edge extracting unit 191, an extending unit 192, and a low-pass filter (LPF) 193.

The edge extracting unit 191 extracts an edge of the blur-corrected image, generates an image with pixel values of pixels included in the extracted edge being taken as 0 and pixel values of pixels not included in the edge being taken as 1 (referred to below as an edge image), and then supplies the edge image to the extending unit 192.

Based on the PSF of the blurred image supplied from the PSF calculating unit 151 of the blur correcting unit 111, the extending unit 192 extends an edge region (a region where the pixel values are 0) of the edge image in a direction in which the blur of the blurred image has occurred. The extending unit 192 then supplies the resultant image (referred to below as an edge-extended image) to the LPF 193.

The LPF 193 attenuates high-frequency components of the edge-extended image, and then supplies the resultant image as a mask image to the combining unit 173.

The combining unit 173 uses the mask image generated by the mask generating unit 172 to combine the high-frequency blurred image with the blur-corrected image supplied from the TV filter 157 of the blur correcting unit 111. The combining unit 173 then outputs the resultant image as an output image to an apparatus of the subsequent stage.

Example of Image Correction

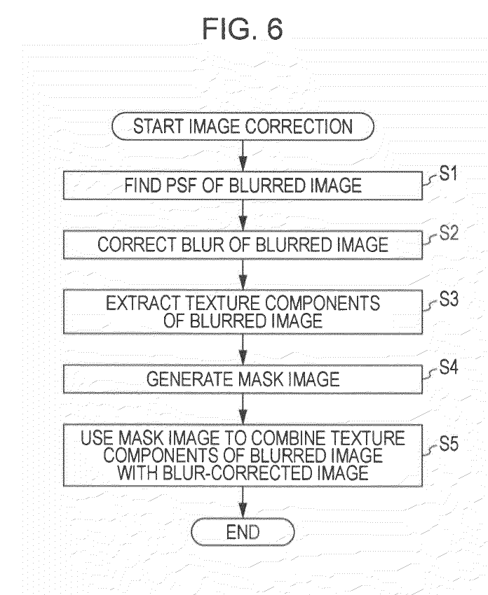

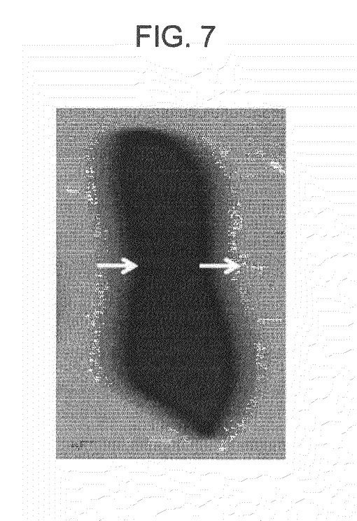

Next, with reference to a flowchart of FIG. 6, image correction to be performed by the image processing apparatus 101 is described. Here, in the following, description is made by taking the case in which a blurred image depicted in FIG. 7 is processed as a specific example as appropriate. In the blurred image of FIG. 7, hand shake has occurred in a direction indicated by arrows at the time of shooting, thereby causing a blur in the image.

This process starts when, for example, a blurred image to be corrected is inputted to the image processing apparatus 101 and an instruction for performing image correction is provided via an operating unit not shown. Also, the blurred image inputted in the image processing apparatus 101 is supplied to the PSF calculating unit 151, the initial blur correcting unit 152, and the residual calculating unit 154 of the blur correcting unit 111 and the LPF 181 and the subtracting unit 182 of the texture extracting unit 171 of the texture reconstructing unit 112.

At step S1, the PSF calculating unit 151 uses a predetermined technique to find a PSF of the blurred image. For example, the PSF calculating unit 151 detects a characteristic point on a cepstrum in luminance values (Y components) of pixels configuring the blurred image to perform linear estimation of a PSF, thereby finding a PSF of the blurred image. The PSF calculating unit 151 then supplies the found PSF to the convolution calculating unit 153, the correlation calculating unit 155, and the extending unit 192 of the mask generating unit 172 of the texture reconstructing unit 112.

Here, any technique for the PSF calculating unit 151 to find a PSF of the blurred image can be adopted.

At step S2, the blur correcting unit 111 corrects the blur of the blurred image. Specifically, based on the PSF found by the PSF calculating unit 151, the initial blur correcting unit 152 corrects the blur of the blurred image by using a predetermined technique, and then supplies the resultant initial blur-corrected image to the convolution calculating unit 153 and the multiplying unit 156.

Here, any technique for the initial blur correcting unit 152 to correct the blurred image can be adopted.

The convolution calculating unit 153 performs a convolutional operation between the initial blur-corrected image and the PSF of the blurred image to generate a reproduced blurred image. The convolution calculating unit 153 then supplies the generated reproduced blurred image to the residual calculating unit 154.

The residual calculating unit 154 calculates a residual between the reproduced blurred image generated by the convolution calculating unit 153 and the original blurred image. The residual calculating unit 154 then supplies the operation result to the correlation calculating unit 155.

The correlation calculating unit 155 performs a correlation operation between the PSF of the blurred image and the operation result from the residual calculating unit 154, and remove blur components of the blurred image from the residual between the reproduced blurred image and the blurred image. The correlation calculating unit 155 then supplies the operation result to the multiplying unit 156.

The multiplying unit 156 multiplies the initial blur-corrected image by the operation result from the correlation calculating unit 155, and then supplies the resultant image to the TV filter 157.

The TV filter 157 separates structure components and texture components of the image generated by the multiplying unit 156, and then supplies the resultant image formed of the structure components as a blur-corrected image to the convolution calculating unit 153 and the multiplying unit 156.

The convolution calculating unit 153 performs a convolutional operation between the blur-corrected image generated by the TV filter 157 and the PSF of the blurred image to generate a reproduced blurred image. The convolution calculating unit 153 then supplies the generated reproduced blurred image to the residual calculating unit 154.

The residual calculating unit 154 calculates a residual between the reproduced blurred image generated by the convolution calculating unit 153 and the original blurred image. The residual calculating unit 154 then supplies the operation result to the correlation calculating unit 155.

The correlation calculating unit 155 performs a correlation operation between the PSF of the blurred image and the operation result from the residual calculating unit 154, and removes blur components from the residual between the reproduced blurred image and the blurred image. The correlation calculating unit 155 then supplies the operation result to the multiplying unit 156.

The multiplying unit 156 multiplies the blur-corrected image generated by the TV filter 157 by the operation result from the correlation calculating unit 155, and then supplies the resultant image to the TV filter 157.

The TV filter 157 separates structure components and texture components of the image generated by the multiplying unit 156, and then supplies the resultant image formed of the structure components as a blur-corrected image to the convolution calculating unit 153 and the multiplying unit 156.

Then, for example, until the residual between the reproduced blurred image and the original blurred image has a value equal to or smaller than a predetermined threshold or until the number of operations reaches a predetermined number, a process of updating the blur-corrected image is repeated based on the residual between the reproduced blurred image and the original blurred image so as to decrease the residual. When the residual between the reproduced blurred image and the original blurred image has a value equal to or smaller than the predetermined threshold or when the number of operations reaches the predetermined number, the TV filter 157 supplies the generated blur-corrected image to the edge extracting unit 191 in the mask generating unit 172 in the texture reconstructing unit 112 and to the combining unit 173 therein.

Here, the PSF of the blurred image may also be sequentially updated based on, for example, the residual between the reproduced blurred image and the original blurred image.

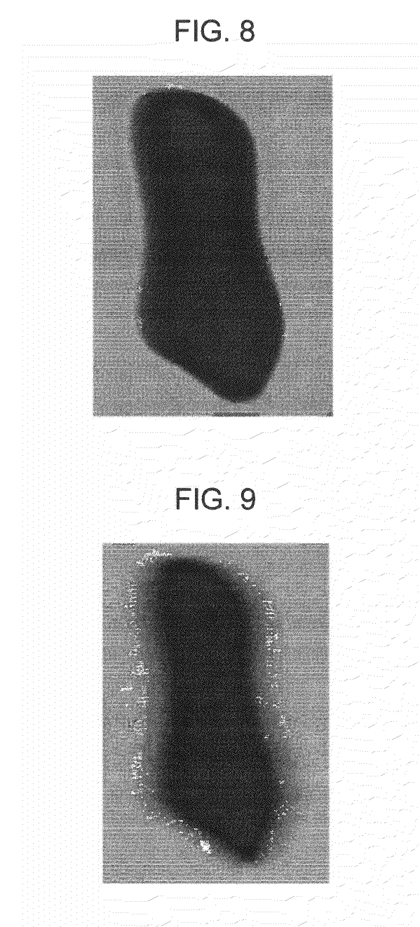

FIG. 8 illustrates a blur-corrected image obtained by correcting the blur of the blurred image of FIG. 7 with the processes at steps S1 and S2.

At step S3, the texture extracting unit 171 of the texture reconstructing unit 112 extracts texture components of the blurred image. Specifically, the LPF 181 of the texture extracting unit 171 attenuates frequency components of the blurred image higher than a predetermined threshold, and then supplies a blurred image obtained by attenuating the high-frequency components to the subtracting unit 182.

FIG. 9 illustrates an image obtained by attenuating the high-frequency components of the blurred image of FIG. 7, at the LPF 181.

The subtracting unit 182 finds a difference between the blurred image and a blurred image obtained by attenuating high-frequency components at the LPF 181, and extracts the high-frequency components of the blurred image. The subtracting unit 182 then supplies a high-frequency blurred image representing the extracted high-frequency components to the multiplying unit 183.

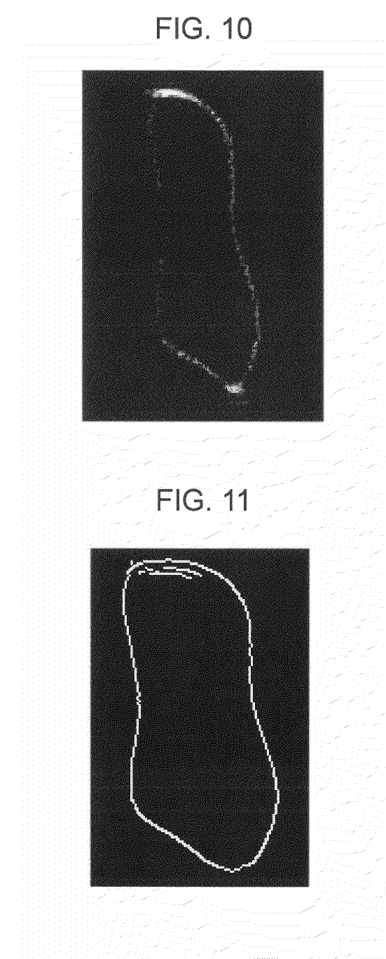

FIG. 10 illustrates a high-frequency blurred image obtained by finding a difference between the blurred image of FIG. 7 and the blurred image of FIG. 9 obtained by attenuating the high-frequency components. In the high-frequency blurred image of FIG. 10, together with the texture components of the blurred image of FIG. 7, an edge of the subject at the center and a blur of the edge are represented.

The multiplying unit 183 multiples each pixel value of the high-frequency blurred image by an enhancement-effect parameter set by the user, thereby enhancing the high-frequency components of the high-frequency blurred image. The multiplying unit 183 then supplies a high-frequency blurred image obtained by enhancing the high-frequency components to the combining unit 173.

At step S4, the mask generating unit 172 of the texture reconstructing unit 112 generates a mask image. Specifically, the edge extracting unit 191 of the mask generating unit 172 extracts an edge of the blur-corrected image. The edge extracting unit 191 generates a binary edge image by setting pixel values of pixels included in the extracted edge at 0, which is a value indicating removal from a combination range by the combining unit 173, and setting pixel values of pixels not included in the edge at 1. The edge extracting unit 191 supplies the generated edge image to the extending unit 192.

FIG. 11 illustrates an edge image generated from the blur-corrected image of FIG. 8.

Based on the PSF of the blurred image, the extending unit 192 extends an edge region (a region in which the pixel values are 0) of the edge image in a direction in which the blur of the blurred image has occurred, and then supplies the resultant edge-extended image to the LPF 193.

The LPF 193 attenuates frequency components of the edge-extended image higher than a predetermined threshold, and then supplies the resultant image, that is, a mask image, to the combining unit 173.

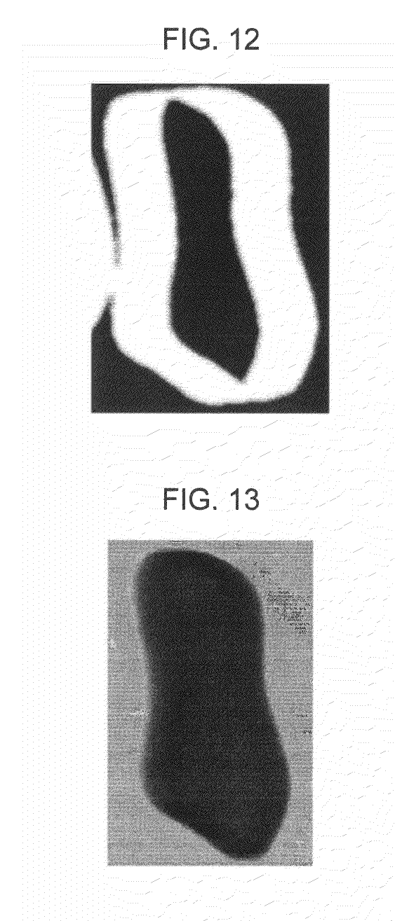

FIG. 12 illustrates a mask image by extending the edge region by the extending unit 192 and then attenuating the high-frequency components by the LPF 193, on the edge image of FIG. 11. Although not shown, since the edge-extended image before attenuating the high-frequency components by the LPF 193 is a binary image with any of its pixel values being 0 or 1, pixel values near a boundary (a boundary between an edge portion and a non-edge portion) of the mask abruptly change from 0 to 1. On the other hand, the mask image obtained after attenuating the high-frequency components by the LPF 193 has pixel values in a range of 0 to 1 below a decimal point. Thus, the pixel values gradually change near the boundary of the mask, compared with those before the high-frequency components are attenuated.

At step S5, the combining unit 173 uses a mask image to combine the texture components of the blurred image with the blur-corrected image. Specifically, with the following equation (1), the combining unit 173 uses the mask image to combine the blur-corrected image and the high-frequency blurred image and generate an output image.

Po=α×Pc+(1−α)×Ph (1)

Here, Po represents a pixel value of the output image, Pc represents a pixel value of the blur-corrected image, Ph represents a pixel value of the high-frequency blurred image, and α represents a pixel value of the mask image.

The combining unit 173 then outputs the generated output image to an apparatus of the subsequent stage. Then, image correction ends.

Summary of Effects

FIG. 13 illustrates an output image obtained by combining the blur-corrected image of FIG. 8 and the high-frequency blurred image of FIG. 10 by using the mask image of FIG. 12. In comparison between the blur-corrected image of FIG. 8 and the output image of FIG. 13, it can be found that the output image of FIG. 13 is more finely represented, particularly in changes of shadow inside the subject at the center, and the sense of resolution is thus increased.

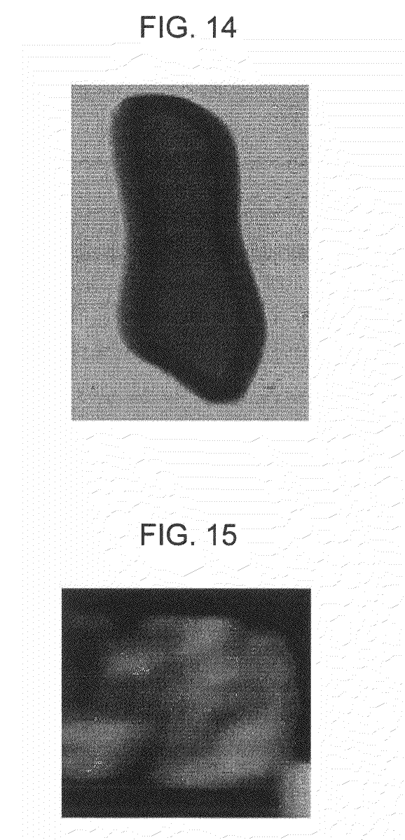

FIG. 14 illustrates an image obtained by combining the blur-corrected image of FIG. 8 and the high-frequency blurred image of FIG. 10 without using the mask image of FIG. 12. As described above, the high-frequency blurred image of FIG. 10 includes not only the texture components of the blurred image but also the edge of the subject at the center and a blur of the edge. Therefore, when the blur-corrected image of FIG. 8 and the high-frequency blurred image of FIG. 10 are combined without using the mask image, as depicted in FIG. 14, while the sense of resolution of the image is increased, not only the texture components of the blurred image but also the edge of the blurred image and the blur of the edge are superposed each other, thereby disadvantageously causing artifacts.

On the other hand, in the output image of FIG. 13, the high-frequency blurred image is combined with the blur-corrected image by using the mask image, thereby attenuating or removing a portion of the high-frequency blurred image in a region of the blurred image where the edge is present and a blur of the edge has occurred. Therefore, artifacts due to the edge of the blurred image or a blur of the edge do not occur.

Also, by using an image obtained by attenuating the high-frequency components of the edge-extended image as a mask image, it is possible to suppress discontinuity of changes of the image near the boundary of the mask and unnatural look.

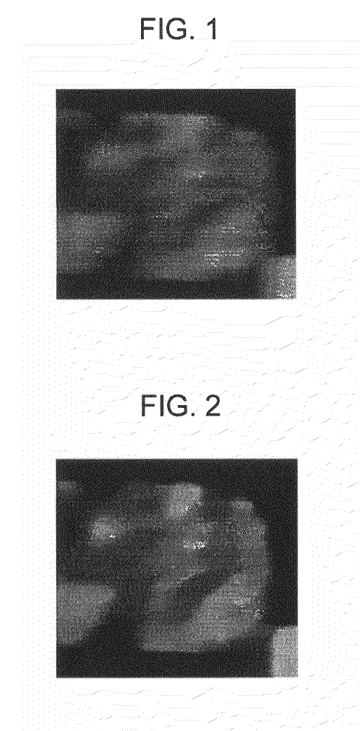

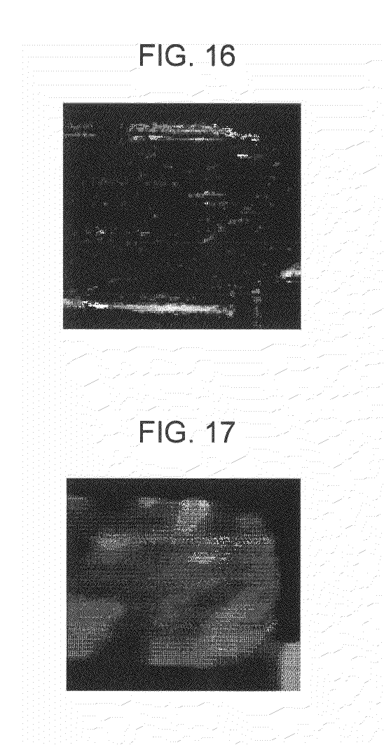

FIG. 15 to FIG. 17 illustrate the results after image correction of FIG. 6 is performed on the blur-corrected image of FIG. 2 described above. Specifically, FIG. 15 illustrates an image obtained by attenuating high-frequency components of the blurred image of FIG. 1 at the LPF 181. FIG. 16 illustrates a high-frequency blurred image obtained by finding a difference between the blurred image of FIG. 1 and the blurred image of FIG. 15 obtained by attenuating the high-frequency components. FIG. 17 illustrates an output image obtained by combining the blur-corrected image of FIG. 2 and the high-frequency blurred image of FIG. 16 by using a mask image not shown.

In comparison between the blur-corrected image of FIG. 2 and the output image of FIG. 17, it can be found that the output image of FIG. 17 is more finely represented, particularly in changes of pattern inside the subject at the center, and the sense of resolution is thus increased.

In such a manner as described above, the texture components of the image in which the sense of resolution is decreased due to blur correction can be easily and appropriately reconstructed, thereby increasing the sense of resolution of the image. In particular, when most of the texture components are lost in a blur-corrected image, even if post-processing is performed by using an unsharp mask or the like, the sense of resolution can be increased little. Even in such cases, however, in the embodiment of the present invention, the texture components can be reconstructed, thereby increasing the sense of resolution.

### 2. Modification Example

Here, in the embodiment of the present invention, even for an image in which the sense of resolution is decreased due to blur correction by using a method other than the method described above, the texture components can be reconstructed, thereby increasing the sense of resolution.

Also, in the embodiment of the present invention, even when a mask image is not used or even when a binary mask image is used as it is without attenuating the high-frequency components of the mask image, the sense of resolution of the blur-corrected image can be increased. As described above, however, by using the mask image obtained by attenuating the high-frequency components, the image quality of the output image can be more increased.

Furthermore, for example, the blur correcting unit 111 and the texture reconstructing unit 112 may be provided to different apparatuses.

Still further, the embodiment of the present invention can be applied to, for example, a camera that shoots and records an image, a recording apparatus that records a shot image, and a reproducing apparatus that reproduces a shot image.

Meanwhile, the series of processing described above can be executed by dedicated hardware or software. When the series of processing is executed by software, a program configuring the software is installed from a program storage medium to a computer, such as a so-called built-in-type computer or a general-purpose personal computer capable of executing various functions by installing various programs.

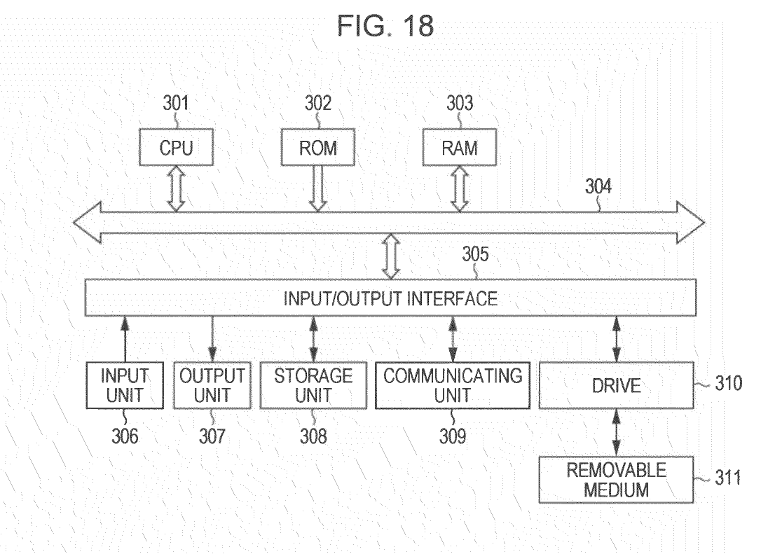

FIG. 18 illustrates an example of the structure of a computer executing the series of processing described above by way of a program.

A central processing unit (CPU) 301 executes various processes according to a program stored in a read only memory (ROM) 302 or a storage unit 308. In a random access memory (RAM) 303, a program to be executed by the CPU 301 and data are stored as appropriate. These CPU 301, ROM 302, and RAM 303 are connected to each other via a bus 304.

To the CPU 301, an input/output interface 305 is also connected via the bus 304. To the input/output interface 305, an input unit 306 formed of a keyboard, a mouse, a microphone, and others and an output unit 307 formed of a display, a loudspeaker, and others are connected. The CPU 301 executes various processes in response to instructions inputted from the input unit 306. The CPU 301 then outputs the process results to the output unit 307.

The storage unit 308, which is connected to the input/output interface 305, is implemented by, for example, a hard disk, which stores programs to be executed by the CPU 301 and various pieces of data. A communicating unit 309 communicates with an external apparatus via a network, such as the Internet or a local area network.

Also, a program may be obtained via the communicating unit 309 and then stored in the storage unit 308.

When a removable medium 311, such as a magnetic disk, an optical disk, a magneto-optical disk, or a semiconductor memory, is inserted, a drive 310, which is connected to the input/output interface 305, drives the removable medium 311, thereby obtaining a program, data, and others recorded thereon. The obtained program and data are transferred to the storage unit 308 and stored as necessary.

Examples of a program storage medium for storing a program to be installed on a computer and caused to be executable by the computer are, as depicted in FIG. 18, the removable medium 311, which is a package medium formed of a magnetic disk (including a flexible disc), an optical disk (including a compact disc-read only memory (CD-ROM) and a digital versatile disc (DVD)), an magneto-optical disk (including a mini-disc (MD)), or a semiconductor memory, the ROM 302 having a program temporarily or permanently stored, and the hard disk configuring the storage unit 308. A program is stored in the program storage medium via the communicating unit 309, which is an interface, such as a router or a modem, as necessary, or using a wired or wireless communication medium, such as a local area network, the Internet, or digital satellite broadcast.

Here, in the specification, steps describing a program stored in the program storage medium include not only processes to be performed in a time series along a described sequence but also processes to be executed not necessarily in a time series but concurrently or individually.

The present application contains subject matter related to that disclosed in Japanese Priority Patent Application JP 2009-242242 filed in the Japan Patent Office on Oct. 21, 2009, the entire content of which is hereby incorporated by reference.

It should be understood that embodiments of the present invention are not limited to the above-mentioned embodiments and various alterations may occur as they are within the scope of the present invention.

What is claimed is:

1. An image processing apparatus comprising:
a texture extracting unit extracting a texture component of a blurred image in which a blur has occurred; and
a combining unit combining the texture component of the blurred image extracted by the texture extracting unit with a blur-corrected image obtained by correcting the blur of the blurred image.

2. The image processing apparatus according to claim 1, further comprising a mask generating unit extracting an edge of the blur-corrected image, extending the edge of the extracted blur-corrected image in a direction in which the blur of the blurred image has occurred, and generating a binary mask image for removing pixels included in the extended edge from a combining range of the combining unit, wherein the combining unit combines the texture component of the blurred image with the blur-corrected image by using the mask image.

3. The image processing apparatus according to claim 2, wherein:
the mask generating unit further attenuates a frequency component of the mask image higher than a predetermined threshold; and
the combining unit combines the texture component of the blurred image with the blur-corrected image by using the mask image with the high-frequency component attenuated.

4. An image processing method causing an image processing apparatus to perform a process comprising the steps of:
extracting a texture component of a blurred image in which a blur has occurred; and
combining the extracted texture component of the blurred image with a blur-corrected image obtained by correcting the blur of the blurred image.

5. A program causing a computer to perform a process comprising the steps of:
extracting a texture component of a blurred image in which a blur has occurred; and
combining the extracted texture component of the blurred image with a blur-corrected image obtained by correcting the blur of the blurred image.
